(19) United States
(12) Patent Application Publication
(10) Pub. No.: US 2024/0283100 A1
(43) Pub. Date: Aug. 22, 2024

(54) ENERGY STORAGE ELEMENT, ASSEMBLY OF ENERGY STORAGE ELEMENTS AND PRODUCTION PROCESS

(71) Applicant: VARTA Microbattery GmbH, Ellwangen Jagst (DE)

(72) Inventors: Reiko STUTZ, Noerdlingen (DE); Stefan STOCK, Rainau-Dalkingen (DE); Herbert SCHEIN, Munningen (DE); Edward PYTLIK, Ellwangen (DE); David ENSLING, Ellwangen (DE); Stefanie CADUS, Aalen (DE)

(21) Appl. No.: 18/570,137

(22) PCT Filed: Jul. 20, 2022
(86) PCT No.: PCT/EP2022/070425

§ 371 Date: Dec. 14, 2023

(30) Foreign Application Priority Data
Aug. 11, 2021 (WO) PCT/EP2021/072428
Sep. 10, 2021 (EP) 21195983.8

(51) Int. Cl. H01M 50/531; H01M 10/0525; H01M 50/119; H01M 50/516; H01M 50/528; H01M 50/56; H01M 50/578

(52) U.S. Cl. CPC H01M 50/531; H01M 50/516; H01M 50/528; H01M 50/56; H01M 50/578; H01M 10/0525; H01M 50/119

(57) ABSTRACT

An energy storage element includes an air- and liquid-tight housing. The housing includes a metallic, cup-shaped housing part with a housing bottom and a terminal opening. The housing further includes a lid component welded into and closing the terminal opening of the cup-shaped housing part, the lid component including a metallic lid plate and a negative terminal passed through an aperture in the lid plate and electrically insulated from the lid plate. The energy storage element also includes an electrode-separator assembly having a first flat terminal end face, a second flat terminal end face, an anode with an anode current collector having a first edge and a second edge parallel thereto, and a cathode with a cathode current collector having a first edge and a second edge parallel thereto. A contact sheet metal member is seated on the first edge of the anode current collector and connected thereto by welding.

### CROSS REFERENCE TO RELATED APPLICATIONS

This application is a U.S. National Phase application under 35 U.S.C. § 371 of International Patent Application No. PCT/EP2022/070425, filed on Jul. 20, 2022, and claims benefit to International Patent Application No. PCT/EP2021/072428, filed on Aug. 11, 2021, and to European Patent Application No. EP 21195983.8, filed on Sep. 10, 2021. The International Application was published in German on Feb. 16, 2023 as WO 2023/016769 under PCT Article 21(2).

### FIELD

The present disclosure relates to an energy storage element, an assembly of energy storage elements, and a manufacturing method.

### BACKGROUND

Electrochemical energy storage elements can convert stored chemical energy into electrical energy by virtue of a redox-reaction. The simplest form of an electrochemical energy storage element is the electrochemical cell. It comprises a positive and a negative electrode separated by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. if it is possible to reverse the conversion of chemical energy into electrical energy that took place during the discharge and to charge the cell again, this is said to be a secondary cell. The designation of the negative electrode as anode and the designation of the positive electrode as cathode, which is generally used for secondary cells, refers to the discharge function of the electrochemical cell.

Secondary lithium-ion cells are used as energy storage elements for many applications because they can provide high currents and are characterized by a comparatively high energy density. They are based on the use of lithium, which can migrate between the electrodes of the cell in the form of ions. The negative electrode and the positive electrode of a lithium-ion cell are generally formed by so-called composite electrodes, which comprise electrochemically active components as well as electrochemically inactive components.

In principle, all materials that can absorb and release lithium ions can be used as electrochemically active components (active materials) for secondary lithium-ion cells. For the negative electrode, for example, carbon-based particles such as graphitic carbon are used. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) may be formed of copper or nickel, for example, and the current collector for the positive electrode (cathode current collector) may be formed of aluminum, for example. Furthermore, the electrodes may comprise an electrode binder (e.g., polyvinylidene fluoride (PVDF) or another polymer, for example, carboxymethylcellulose), conductivity-enhancing additives, and other additives as electrochemically inactive components. The electrode binder ensures the mechanical stability of the electrodes and often the adhesion of the active material to the current collectors.

As electrolytes, lithium-ion cells generally comprise solutions of lithium salts such as lithium hexafluorophosphate (LiPF₆) in organic solvents (e.g., ethers and esters of carbonic acid).

In the manufacture of a lithium-ion cell, the composite electrodes are combined with one or more separators to form an assembly. In this process, the electrodes and separators are usually connected under pressure, possibly also by lamination or by bonding. The basic functionality of the cell can then be established by impregnating the assembly with the electrolyte.

In many embodiments, the assembly is formed as a winding or made into a winding. Generally, it comprises the sequence positive electrode/separator/negative electrode. Often, assemblies are made as so-called bicells with the possible sequences negative electrode/separator/positive electrode/separator/negative electrode or positive electrode/separator/negative electrode/separator/positive electrode.

For applications in the automotive sector, for e-bikes or also for other applications with high energy requirements, such as in tools, lithium-ion cells with the highest possible energy density are needed that are simultaneously able to be loaded with high currents during charging and discharging.

Cells for the applications mentioned are often designed as cylindrical round cells, for example with the form factor 21×70 (diameter*height in mm) Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

WO 2017/215900 A1 describes cylindrical round cells in which the electrode-separator assembly and its electrodes are ribbon-shaped and are in the form of a winding. The electrodes each have current collectors loaded with electrode material. Oppositely poled electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact plate which is seated on an end face of the winding and is connected to a longitudinal edge of one of the current collectors by welding. This makes it possible to electrically contact the current collector and thus also the associated electrode over its entire length. This significantly reduces the internal resistance within the cell described. The occurrence of large currents can subsequently be much better absorbed and heat can also be better dissipated from the winding.

Cylindrical round cells such as those in WO 2017/215900 A1 are usually used as part of a cell assembly in which several cells are connected together in series and/or in parallel. It is often desirable to contact the cells only at one of their end faces in order to tap an electrical voltage. It is therefore advantageous to provide both a terminal connected to the positive electrode of the cell and a terminal connected to the negative electrode of the cell on one of the end faces.

From US 2006/0019150 A1 a lithium-ion round cell is known, which comprises an electrode-separator assembly in a cylindrical housing, wherein the electrode-separator assembly is formed as a winding. The housing comprises a cylindrical metal housing cup with an opening closed by a metal lid component. The bottom of the housing cup is electrically connected to the positive electrode of the winding, and the housing cup is therefore positively poled. Both housing parts are in direct contact with each other, so the lid component is also positively poled. A positive metallic connection pole is welded onto the lid component. The negative electrode of the winding, on the other hand, is connected to a negative metallic terminal pole, which is led through an aperture in the lid component and is electrically insulated from the lid component. The positive and negative connection poles are thus arranged next to each other on the same side of the cell, so that the cell can be easily integrated into a cell assembly via corresponding current conductors.

In addition to its good contactability, the cell described in US 2006/0019150 A1 also features integrated overpressure protection. For this purpose, the bottom has a central, circular region which is separated from an annular residual region of the bottom by a circumferential weakening line and to which a bent conductor strip is welded on the inside, via which said electrical contact of the bottom to the positive electrode of the winding exists. In case of overpressure inside the housing, the circular region can be blown out of the bottom. Since an annular insulator ensures that the annular residual area has no contact whatsoever with the winding shaped electrode-separator assembly, the electrical connection between the positive electrode and the annular residual area and all components in electrical contact therewith, including the positive terminal pole, is thereby interrupted.

The negative electrode of the winding is electrically contacted via a multiple bent conductor strip, the upper end of which is coupled to the negative terminal pole.

From an energy point of view, the design of the cell described in US 2006/0019150 A1 is not optimal. There is a dead volume at both ends of the winding, which requires the aforementioned conductor strips to bridge it. These have a negative effect on the energy density of the cell. Furthermore, there are also doubts about the reliability of the overpressure protection. If the above-mentioned weakening line does not tear over its entire length when the overpressure protection is triggered, the electrical connection to the positive terminal pole is not completely interrupted and current can continue to flow.

### SUMMARY

In an embodiment, the present disclosure provides an energy storage element. The energy storage element includes an air- and liquid-tight sealed housing. The housing includes a metallic, cup-shaped housing part with a housing bottom and a terminal opening. The housing further includes a lid component welded into and closing the terminal opening of the cup-shaped housing part, the lid component including a metallic lid plate and a negative terminal passed through an aperture in the lid plate and electrically insulated from the lid plate. The energy storage element also includes an electrode-separator assembly having a first flat terminal end face, a second flat terminal end face, an anode with an anode current collector having a first edge and a second edge parallel thereto. The anode current collector includes a main region loaded with a layer of negative electrode material and a free edge strip, extending along the first edge of the anode current collector, which is not loaded with the electrode material. The electrode separator assembly further includes a cathode with a cathode current collector having a first edge and a second edge parallel thereto. The cathode current collector includes a main region loaded with a layer of positive electrode material and a free edge strip, extending along the first edge of the cathode current collector, which is not loaded with the electrode material. The anode and the cathode are arranged within the electrode-separator assembly such that the first edge of the anode current collector protrudes from the first terminal end face and the first edge of the cathode current collector protrudes from the second terminal end face of the electrode-separator assembly. A contact sheet metal member is seated on the first edge of the anode current collector and connected thereto by welding, the contact sheet metal member being electrically connected to the negative terminal passing through the aperture in the lid plate. The negative terminal comprises a first contacting portion made of nickel or copper or titanium or a nickel alloy or a copper alloy or a titanium alloy or stainless steel, and a second contacting portion made of aluminum or an aluminum alloy. The second contacting portion can be contacted mechanically from outside the housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an embodiment of an energy storage element and its behavior in the event of overpressure as a result of a malfunction (cross-sectional illustrations),

FIG. 2 illustrates an electrode-separator assembly that is part of the energy storage element shown in FIG. 1, and its components,

FIG. 3 illustrates two contact sheet metal members that are components of the energy storage element shown in FIG. 1, and

FIG. 4 illustrates the assembly of a negative terminal pole according to an embodiment (cross-sectional views).

### DETAILED DESCRIPTION

The present disclosure provides energy storage elements which are characterized by an improved energy density compared with the prior art and which can be efficiently processed to form a cell assembly. Furthermore, the energy storage elements should also be characterized by improved safety.

The present disclosure provides an energy storage element, an assembly of energy storage elements, and a manufacturing process.

### Energy Storage Element

The energy storage element according to the present disclosure includes the immediately following features a. to l.:
a. It comprises an air- and liquid-tight sealed housing and an electrode-separator assembly disposed therein.
b. The housing comprises a metal cup-shaped housing part that comprises a housing bottom and a terminal opening.
c. The housing comprises a lid component that is welded into and closes the terminal opening of the cup-shaped housing part.
d. The lid component comprises a metallic lid plate and a terminal pole which is passed through an aperture in the lid plate and is electrically insulated from the lid plate.
e. The electrode-separator assembly comprises first and second flat terminal end faces.
f. The electrode-separator assembly comprises an anode with an anode current collector having a first edge and a second edge parallel thereto.
g. The anode current collector comprises a main region loaded with a layer of negative electrode material and a free edge strip extending along its first edge that is not loaded with the electrode material.
h. The electrode-separator assembly comprises a cathode with a cathode current collector having a first edge and a second edge parallel thereto.
i. The cathode current collector comprises a main region loaded with a layer of positive electrode material and a free edge strip extending along its first edge that is not loaded with the electrode material.
j. The anode and the cathode are arranged within the electrode-separator assembly such that the first edge of the anode current collector protrudes from the first terminal end face and the first edge of the cathode current collector protrudes from the second terminal end face of the electrode-separator assembly.
k. The energy storage element comprises a contact sheet metal member that is seated on the first edge of the anode current collector and is connected to it by welding.
l. The contact sheet metal member is connected electrically to the terminal pole passing through the aperture in the lid plate.

Preferably, the energy storage element with features a. to l has the following additional features m. and n. below:
m. The terminal pole comprises a first contacting portion made of nickel or copper or titanium or a nickel alloy or a copper alloy or a titanium alloy or stainless steel and a second contacting portion made of aluminum or an aluminum alloy.
n. The second contacting portion can be contacted mechanically from outside the housing.

The energy storage element is thus preferably characterized by a terminal pole which comprises two different metallic materials, nickel or copper or titanium or the nickel alloy or the copper alloy or the titanium alloy or stainless steel on the one side and aluminum or the aluminum alloy on the other side. And since the terminal pole is electrically coupled to the anode current collector via the contact sheet metal member, the terminal pole is a negative terminal pole.

Energy storage elements with such a negative terminal offer the significant advantage that they can be easily integrated into a cell assembly. Poles of several energy storage elements are interconnected via a common current conductor. In terms of production technology, it can be advantageous to weld the poles of the cells to the current conductor by means of a laser. Generally this is unproblematic only if the materials to be welded are the same. For example, welding a terminal pole made of copper to a current conductor made of aluminum using a laser is difficult or impossible. With the second contacting portion made of aluminum or an aluminum alloy, on the other hand, this is possible without any problems. Thus, even negative connection poles of a cell can be connected by laser via a common current conductor.

It is preferred that the terminal pole comprises a first contacting portion made of nickel or copper or a nickel alloy or a copper alloy or stainless steel and a second contacting portion made of aluminum or an aluminum alloy.

Suitable aluminum alloys are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of said alloys is preferably above 99.5%. Suitable stainless steels are, for example, stainless steels of type 1.4303 or 1.4404 or of type SUS304 or nickel-plated steels. In particular, materials of type EN CW-004A or EN CW-008A with a copper content of at least 99.9% can be used as copper alloys. Nickel alloys of the type NiFe, NiCu, CuNi, NiCr and NiCrFe are suitable.

### Aluminum Housing

In an embodiment, the energy storage element has at least one of the immediately following features a. to d.:
a. The cup-shaped housing part consists of aluminum or aluminum alloy.
b. The lid plate consists of aluminum or aluminum alloy.
c. The lid component comprises a separate terminal pole which is fixed to the lid plate, in particular welded to the lid plate, and which consists of aluminum or an aluminum alloy.
d. The cup-shaped housing part and the lid plate and the separate terminal pole consist of aluminum or an aluminum alloy.

It is preferred that the immediately preceding features a. and b., preferably also features a. to c. and a. to d., are realized in combination.

In this embodiment, the housing of the energy storage element consists essentially entirely of aluminum or the aluminum alloy (except for the negative terminal and its insulation). This has various advantages. The formation of localized elements in the event of contact of the outside of the cell with moisture is eliminated. The housing itself can basically serve as a positive connection pole on all its sides. However, it is preferable for the cell to be contacted exclusively via the lid component, where the negative terminal pole is also located. For this purpose, a conductor can be welded directly to the lid plate or alternatively fixed to the separate connection pole, for example by means of welding. In this case, the separate connection pole is the positive connection pole.

Suitable aluminum alloys for the cup-shaped housing part and the lid plate are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of said alloys is preferably above 99.5%.

In preferred embodiments, the energy storage element is a prismatic or a round cell.

### Prismatic Embodiment

In an embodiment, the housing is prismatic. In this embodiment, the bottom of the cup-shaped housing part and the lid component preferably have a polygonal, preferably a rectangular base. The shape of the terminal opening of the cup-shaped housing part corresponds to the shape of the bottom and the lid component. In addition, the housing comprises a plurality of, preferably four, rectangular side portions interconnecting the bottom and the lid component. In this embodiment, the electrode-separator assembly is preferably also prismatic in shape. In this case, the electrode-separator assembly is preferably a prismatic stack comprising a plurality of anodes, cathodes and at least one separator, wherein the electrode-separator assembly within the stack has the sequence anode/separator/cathode.

At least the anodes and cathodes preferably have a rectangular base area, wherein the current collectors of the anodes and the cathodes each have the first edge and the second edge parallel thereto and each have along their first edge the free edge strip which is not coated with the respective electrode material. In the case of a plurality of separators between the anodes and cathodes, the separators preferably also have a rectangular base. However, it is also possible that a ribbon-shaped separator is used to separate multiple anodes and cathodes within the stack.

For example, the first and second flat terminal end faces of the stack are two opposite or adjacent sides of the stack. The first edges of the anode current collectors protrude from one of these end faces, and the first edges of the cathode current collectors protrude from the other. The contact sheet metal member sits on the first edges of the anode current collectors and is connected to them by welding.

### Embodiment as Cylindrical Round Cell

In an embodiment, the energy storage element has a combination of the immediately following features a. to o.:
a. The terminal opening of the cup-shaped housing part is circular in shape, and the cup-shaped housing part comprises a cylindrical housing shell,
b. the lid component, which closes the circular opening of the cup-shaped housing part, has a circular circumference,
c. the electrode-separator assembly is in the form of a cylindrical winding which, in addition to the first and second flat terminal end faces, has a winding shell located between the end faces,
d. in the housing, the electrode-separator assembly is axially aligned so that the winding shell abuts the inside of the cylindrical housing shell,
e. the anode and the anode current collector are ribbon-shaped, wherein the anode current collector comprises a first longitudinal edge and a second longitudinal edge and two ends,
f. the first and the parallel second edge of the anode current collector are the longitudinal edges of the ribbon-shaped anode current collector,
g. the main region of the anode current collector loaded with a layer of negative electrode material is strip-shaped,
h. the free edge strip extends along the first longitudinal edge of the anode current collector,
i. the cathode and the cathode current collector are ribbon-shaped, wherein the cathode current collector comprises a first longitudinal edge and a second longitudinal edge and two ends,
j. the first and the second parallel edges of the cathode current collector are the longitudinal edges of the ribbon-shaped cathode current collector,
k. the main region of the cathode current collector loaded with a layer of positive electrode material is strip-shaped,
l. the free edge strip extends along the first longitudinal edge of the cathode current collector,
m. the separator or separators of the electrode-separator assembly are ribbon-shaped,
n. the anode and the cathode are arranged within the electrode-separator assembly such that the first longitudinal edge of the anode current collector protrudes from the first terminal end face and the first longitudinal edge of the cathode current collector protrudes from the second terminal end face of the electrode-separator assembly; and
o. the contact sheet metal member sits on the first longitudinal edge of the anode current collector and is connected to it by welding.

In this embodiment, the electrode-separator assembly preferably comprises one ribbon-shaped separator or two ribbon-shaped separators, each having a first and a second longitudinal edge and two ends. The electrode-separator assembly comprises the electrodes and the separator(s) with the sequence anode/separator/cathode.

Preferably, the energy storage element has the immediately following feature:
a. The housing comprises a lid component that is welded into and closes the terminal opening of the cup-shaped housing part.

Preferably, the lid component with the circular circumference is arranged in the circular opening of the cup-shaped housing part such that its edge abuts the inside of the cup-shaped housing part along a circumferential contact zone, wherein the edge of the lid component is connected to the cup-shaped housing part by a circumferential weld seam.

Preferably, the height of energy storage elements designed as cylindrical round cells is in the range from 50 mm to 150 mm. The diameter of the cylindrical round cells is preferably in the range from 15 mm to 60 mm. Cylindrical round cells with these form factors are suitable for supplying power to electric drives in motor vehicles.

If the energy storage element is designed as a cylindrical round cell, it preferably has a diameter of 26 mm and a height of 105-106 mm.

In embodiments in which the cell is a cylindrical round cell, the anode current collector, the cathode current collector, and the separator or separators preferably have the following dimensions:
A length in the range from 0.5 m to 25 m
A width in the range from 30 mm to 145 mm

In these cases, the free edge strip extending along the first longitudinal edge, which is not loaded with the electrode material, preferably has a width of no more than 5000 μm.

### Electrochemical Embodiment

In another embodiment, the energy storage element is characterized by one of the following features:
a. The energy storage element is a lithium-ion cell.
b. The energy storage element comprises a lithium-ion cell.

Feature a. refers in particular to the described embodiment of the energy storage element as a cylindrical round cell. In this embodiment, the energy storage element preferably comprises exactly one electrochemical cell.

Feature b. refers in particular to the described prismatic embodiment of the energy storage element. In this embodiment, the energy storage element may also comprise more than one electrochemical cell.

Basically all electrode materials known for secondary lithium-ion cells can be used for the electrodes of the energy storage element.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof may be included in the negative electrode, preferably also in particulate form. Furthermore, the negative electrode may contain as active material at least one material from the group comprising silicon, aluminum, tin, antimony, or a compound or alloy of these materials that is capable of reversibly depositing and removing lithium, for example silicon oxide (in particular SiOₓ with 0<x<2), optionally in combination with carbon-based active materials. Tin, aluminum, antimony, and silicon can form intermetallic phases with lithium. The capacity to absorb lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Furthermore, lithium nickel manganese cobalt oxide (NMC) with the chemical formula LiNiₓMn_{y}Co_{z}O₂ (wherein x+y+z is typically 1) are well suited, Lithium manganese spinel (LMO) having the chemical formula LiMn₂O₄, or lithium nickel cobalt alumina (NCA) having the chemical formula LiNiₓCo_{y}Al_{z}O₂ (wherein x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of said materials can also be used. Also the cathodic active materials are preferably used in particulate form.

In addition, the electrodes of an energy storage element preferably contain an electrode binder and/or an additive to improve electrical conductivity. The active materials are preferably embedded in a matrix of the electrode binder, wherein adjacent particles in the matrix are preferably in direct contact with each other. Conducting agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose, or mixtures of different binders. Common conductive agents are carbon black, fine graphites, carbon fibers, carbon nanotubes and metal powders.

The energy storage element preferably comprises an electrolyte, in the case of a lithium-ion cell in particular an electrolyte based on at least one lithium salt such as lithium hexafluorophosphate (LiPF₆) dissolved in an organic solvent (e.g. in a mixture of organic carbonates or a cyclic ether such as THF or a nitrile). Other lithium salts that can be used include lithium tetrafluoroborate (LiBF₄), lithium bis(trifluoromethanesulfonyl)imide (LiTFSI), lithium bis(fluorosulfonyl)imide (LiFSI), and lithium bis(oxalato)borate (LiBOB).

The nominal capacity of a lithium-ion-based energy storage element designed as a cylindrical round cell is preferably up to 15000 mAh. With the form factor of 21×70, the energy storage element in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range from 1000 mAh to 5000 mAh, preferably in the range from 2000 to 4000 mAh.

In the European Union, manufacturers are strictly regulated in providing information on the nominal capacities of secondary batteries. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard, and information on the nominal capacity of secondary lead-acid batteries must be based on measurements according to the IEC/EN 61056-1 standard. Any information on nominal capacities in the present application is preferably also based on these standards.

### Embodiments of the Separator

Preferably, the separator or separators are formed from electrically insulating plastic films. It is preferred that the separators can be penetrated by the electrolyte. For this purpose, the plastic films used may, for example, have micropores. The foil can consist of a polyolefin or a polyetherketone, for example. Nonwovens and fabrics made of plastic materials or other electrically insulating sheet structures can also be used as separators. Preferably, separators are used that have a thickness in the range from 5 μm to 50 μm.

In some preferred embodiments, separators are used that are coated or impregnated with ceramic particles (e.g., Al₂O₃ or SiO₂) on one or both sides.

In particular in the prismatic embodiments of the energy storage element, the separator or separators of the assembly may also be one or more layers of a solid electrolyte.

### Structure of an Electrode-Separator Assembly in the Form of a Winding

The ribbon-shaped anode, the ribbon-shaped cathode and the ribbon-shaped separator(s) are preferably wound spirally in the electrode-separator assembly in the form of a winding. To produce the electrode-separator assembly, the ribbon-shaped electrodes are fed together with the ribbon-shaped separator(s) to a winding device, in which they are preferably wound spirally around a winding axis. In some embodiments, the electrodes and the separator are wound onto a cylindrical or hollow-cylindrical winding core, which sits on a winding mandrel and remains in the winding after winding.

The winding shell can be formed by a plastic film or an adhesive tape, for example. It is also possible that the winding shell is formed by one or more separator windings.

### Embodiments of the Current Collectors

The current collectors of the energy storage element have the function of electrically contacting electrochemically active components contained in the respective electrode material over as large an area as possible. Preferably, the current collectors consist of a metal or are at least metallized on the surface.

In the case of an energy storage element designed as a lithium-ion cell, suitable metals for the anode current collector are, for example, copper or nickel or other electrically conductive materials, in particular copper and nickel alloys or metals coated with nickel. In particular, materials of the type EN CW-004A or EN CW-008A with a copper content of at least 99.9% can be used as copper alloys. Nickel alloys of the type NiFe, NiCu, CuNi, NiCr and NiCrFe are suitable. Nickel alloys of the type NiFe, NiCu, CuNi, NiCr and NiCrFe are suitable. Stainless steel is also possible in principle, for example type 1.4303 or 1.4404 or type SUS304.

In the case of an energy storage element designed as a lithium-ion cell, aluminum or other electrically conductive materials, including aluminum alloys, are suitable as the metal for the cathode current collector.

Suitable aluminum alloys for the cathode current collector include Al alloys of types 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of said alloys is preferably above 99.5%.

Preferably, the anode current collector and/or the cathode current collector are each a metal foil with a thickness in the range from 4 μm to 30 μm, and in the case of the described configuration of the energy storage element as a cylindrical round cell, a ribbon-shaped metal foil with a thickness in the range from 4 μm to 30 μm.

In addition to foils, however, other ribbon-shaped substrates such as metallic or metallized nonwovens or open-pore metallic foams or expanded metals can be used as current collectors.

The current collectors are preferably loaded on both sides with the respective electrode material.

In the case of the described configuration of the energy storage element as a cylindrical round cell, it is preferred that the longitudinal edges of the separator(s) form the end faces of the winding-shaped electrode-separator assembly.

In the case of the prismatic configuration of the energy storage element described, it is preferred that the edges of the separator(s) form the end faces of the stack from which the edges of the current collectors protrude.

It is further preferred that the edges or longitudinal edges of the anode current collector and/or the cathode current collector protruding from the terminal faces of the winding or sides of the stack do not protrude more than 5000 μm, preferably not more than 3500 μm.

Preferably, the edge or longitudinal edge of the anode current collector protrudes from the side of the stack or the end face of the winding no more than 2500 μm, especially preferably no more than 1500 μm. Preferably, the edge or longitudinal edge of the cathode current collector protrudes from the side of the stack or the end face of the winding no more than 3500 μm, especially preferably no more than 2500 μm.

Direct contact of the edge of the anode current collector with the contact sheet metal member lowers the internal resistance of the energy storage element and thus elevates its current-carrying capacity.

### Embodiments of the Contact Sheet Metal Member/Connection of the Contact Sheet Metal Member to the Anode Current Collector and the Negative Terminal Pole

The contact sheet metal member is connected electrically to the negative terminal led through the aperture in the lid plate and to the anode current collector. In particular, it is welded directly to the first contacting portion and/or the anode current collector.

In a preferred embodiment, the contact sheet metal member electrically connected to the negative terminal pole is characterized by at least one of the immediately following features a. to c.:
a. The contact sheet metal member consists of nickel or copper or titanium or a nickel or copper or titanium alloy or stainless steel, for example, type 1.4303 or 1.4404 or type SUS304, or nickel-plated copper.
b. The contact sheet metal member consists of the same material as the first contacting portion.
c. The contact sheet metal member consists of the same material as the anode current collector.

It is preferred that the immediately preceding features a. and b., preferably also features a. to c., are realized in combination.

If the contact sheet metal member consists of the same material as the first contacting portion and/or the anode current collector, welding of these components is possible without any problems.

In some embodiments, it may be preferred that the contact sheet metal member is not directly welded to the first contacting portion, but is connected to the first contacting portion via a separate current conductor. In these cases, the separate current conductor is preferably welded to the first contacting portion and the contact sheet metal member. Furthermore, in these cases it is preferred that the separate current conductor consists of the same material as the first contacting portion and/or the contact sheet metal member.

Preferably, the separate current conductor consists of nickel or copper or titanium or a nickel or copper or titanium alloy or of stainless steel, for example of type 1.4303 or 1.4404 or of type SUS304. In particular, materials of the type EN CW-004A or nickel alloys of the type NiFe, NiCu, CuNi, NiCr and NiCrFe can be used as copper alloys. EN CW-008A with a copper content of at least 99.9% can be used. All this also applies to the contact sheet metal member itself.

In another preferred embodiment, the contact sheet metal member electrically connected to the negative terminal pole has at least one of the immediately following features:
a. The contact sheet metal member has a preferably uniform thickness in the range from 50 μm to 600 μm, preferably in the range from 150 μm to 350 μm.
b. The contact sheet metal member has two opposing flat sides and extends substantially in only one dimension.
c. The contact sheet metal member is a disc or a preferably rectangular plate.
d. The contact sheet metal member is dimensioned such that it covers at least 60% of the end face, preferably at least 70%, preferably at least 80%, of the first terminal end face.
e. The contact sheet metal member has at least one aperture, in particular at least one hole and or at least one slot.
f. The contact sheet metal member has at least one bead which appears as an elongated depression on one flat side of the contact sheet metal member and as an elongated elevation on the opposite flat side, wherein the contact sheet metal member rests on the first edge of the anode current collector with the flat side carrying the elongated elevation.
g. The contact sheet metal member is welded to the first edge of the anode current collector in the region from the bead, in particular via one or more weld seams arranged in the bead.

It is preferred that the immediately preceding features a. and b. and d. are realized in combination. In a preferred embodiment, features a. and b. and d. are realized in combination with one of features c. or e. or features f. and g. Preferably, all features a. to g. are realized in combination.

Covering the end face over as large an area as possible is important for the thermal management of the energy storage element. The larger the cover, the more likely it is to contact the first edge of the anode current collector over its entire length. Heat formed in the electrode-separator assembly can thus be dissipated well via the contact sheet metal member.

In some embodiments, it has proven advantageous to subject the edge of the current collector to a pretreatment before the contact sheet metal member is placed on top. In particular, at least one depression corresponding to the at least one bead or the elongated elevation on the flat side of the contact sheet metal member facing the first terminal end face can be folded into the edge.

The edge of the current collector may also have been subjected to directional forming by pretreatment. For example, it can be bent in a defined direction.

The at least one aperture in the contact sheet metal member may be expedient, for example, to allow the electrode-separator assembly to be impregnated with an electrolyte.

### Electrical Connection of the Cathode Current Collector to the Housing/Second Contact Sheet Metal Member

In a further embodiment, the energy storage element has at least one of the immediately following features a. to c.:
a. The energy storage element comprises a second contact sheet metal member which is seated on the first edge of the cathode current collector and is connected thereto by welding.
b. The second contact sheet metal member is electrically connected to the cup-shaped housing part.
c. The second contact sheet metal member consists of aluminum or an aluminum alloy.

It is preferred that the immediately preceding features a. and b., preferably also features a. to c., are realized in combination.

The second contact sheet metal member increases the current-carrying capacity on the cathode side. In addition, the thermal management of the energy storage element is further improved.

Suitable aluminum alloys for the contact sheet metal member include Al alloys of types 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of said alloys is preferably above 99.5%.

The contact sheet metal member seated on the first edge of the cathode current collector is preferably formed similarly to the contact sheet metal member seated on the first edge of the anode current collector, except for its material composition. It preferably has at least one of the following features immediately below a. to g.:
a. The second contact sheet metal member has a preferably uniform thickness in the range from 50 μm to 600 μm, preferably in the range from 150 μm to 350 μm.
b. The second contact sheet metal member has two opposing flat sides and extends substantially in one dimension only.
c. The second contact sheet metal member is a disc or a preferably rectangular plate.
d. The second contact sheet metal member is dimensioned such that it covers at least 60% of the end face, preferably at least 70%, preferably at least 80%, of the second terminal end face.
e. The second contact sheet metal member has at least one aperture, in particular at least one hole and or at least one slot.
f. The second contact sheet metal member has at least one bead which appears as an elongated depression on one flat side of the contact sheet metal member and as an elongated elevation on the opposite flat side, wherein the contact sheet metal member rests on the first edge of the cathode current collector with the flat side carrying the elongated elevation.
g. The second contact sheet metal member is welded to the first edge of the cathode current collector in the region from the bead, in particular via one or more weld seams arranged in the bead.

Again, it is preferred that the immediately preceding features a. and b. and d. are realized in combination. In a preferred embodiment, the features a. and b. and d. are realized in combination with one of the features c. or e. or the features f. and g. Preferably, all features a. to g. are also realized in combination.

The connection or welding of the first edge of the cathode current collector to the second contact sheet metal member is preferably implemented in the same way as the connection of the first edge of the anode current collector described above, i.e. preferably via a weld in the region from the bead.

Furthermore, it may also be preferred here that the edge of the current collector has been subjected to a directional forming by a pretreatment. For example, it can be bent in a defined direction.

In preferred embodiments, the second contact sheet metal member is welded directly to the bottom of the cup-shaped housing part or a portion of the bottom. In further preferred embodiments, the second contact sheet metal member is connected to the bottom of the cup-shaped housing part via a separate current conductor. In the latter case, it is preferred that the separate current conductor is welded to both the bottom of the cup-shaped housing part and the second contact sheet metal member. The separate current conductor preferably consists of aluminum or an aluminum alloy.

In principle, direct connection of the first edge of the cathode current collector to the bottom is also possible. For this purpose, for example, welding can be performed by laser from the outside through the bottom of the cup-shaped housing part.

### Embodiment of the Negative Terminal Pole

In a further preferred embodiment, the energy storage element has at least one of the immediately following features a. to f.:
a. The negative terminal pole comprises a tubular or cup-shaped first part that comprises the first contacting portion.
b. The tubular or cup-shaped part consists of nickel or copper or titanium or nickel or copper or titanium alloy or stainless steel, for example type 1.4303 or 1.4404 or type SUS304
c. The negative terminal pole comprises a terminal tubular or cup-shaped first part having a sheath of nickel or copper or nickel or copper alloy, in particular coated with the nickel or copper or nickel or copper alloy.
d. The negative terminal pole comprises a second part made of aluminum or an aluminum alloy, which comprises the second contacting portion.
e. The second part is fixed to the first part mechanically and/or by welding.
f. The second part comprises a pin-shaped section which is mechanically fixed in the tubular or cup-shaped part, preferably pressed into the tubular or cup-shaped part or fixed in the tubular or cup-shaped part by means of a screw connection.

It is preferred that the immediately preceding features a. and b. are realized in combination. In a preferred embodiment, the features a. and b. are realized in combination with the features d. and e. or in combination with the features d. to f.. In an alternative embodiment, features c., d. and e., preferably the four features c. to f, are realized in combination.

The embodiments in which the first part is tubular or cup-shaped provide a simple and elegant solution for forming the negative terminal pole. The part provides a receptacle for the pin-shaped section of the second part, which can be inserted into the first and fixed there. If necessary, the mechanical fixation can also be supported by an additional welded joint.

The electrical insulation of the negative terminal pole with respect to the lid component can be realized, for example, by an insulating element arranged annularly around the terminal pole. This can consist of glass, a ceramic material, an electrically insulating polymer or a combination of these materials.

### Cid Solution in the Bottom Region

In another embodiment, the energy storage element has a combination of the immediately following features a. to e:
a. The bottom of the cup-shaped housing part comprises an aperture, in particular a preferably circular hole, which is closed by means of a metallic membrane.
b. The metallic membrane is fixed to the cup-shaped housing part by welding.
c. The metallic membrane comprises an indentation in the region from which the membrane extends through the aperture into the interior of the housing.
d. The second contact sheet metal member is electrically insulated from the bottom of the housing.
e. The second contact sheet metal member is connected by welding to the part of the metal membrane extending into the housing interior.

This embodiment provides a way of equipping the energy storage element with a reliable and at the same time space-saving safety function. The metallic membrane can be integrated into a depression in the bottom without any problems. If the electrical insulation against the bottom is designed as a thin plastic foil, for example, the second contact sheet metal member can rest flat on the bottom, separated from it only by the thin foil. If a sufficiently high overpressure occurs inside the housing, the indentation is pressed outwards, wherein the membrane tears off the contact plate. This breaks the electrical contact to the cathode and stops any current flow. If the pressure nevertheless continues to rise, the membrane may burst.

In order to ensure that an occurring internal pressure can act on the indentation in an intended manner, it may be preferable to provide an aperture, in particular a hole, in the second contact plate through which the indented region is in communicating connection with the interior space of the housing.

The thickness of the membrane can be adjusted to the pressure at which the fuse is to trip.

### Embodiment of the Housing Parts

In a further embodiment, the energy storage element has at least one of the immediately following features a. to c.:
a. The bottom of the cup-shaped housing part has a thickness in the range from 200 μm to 2000 μm.
b. The side wall of the cup-shaped housing part has a thickness in the range from 150 μm to 2000 μm.
c. The lid component, in particular the lid plate of the lid component, has a thickness in the range from 200 μm to 2000 μm.

Preferably, the immediately preceding features a. to c. are realized in combination.

### Assembly of Energy Storage Elements

The assembly according to the disclosure is characterized by the following features:
a. The assembly comprises at least two energy storage elements as described herein; and
b. the assembly comprises an electrical conductor of aluminum or aluminum alloy connected to the negative terminal pole of one of the energy storage elements and to a pole of another of the energy storage elements by welding.

The aluminum conductor may be, for example, an aluminum rail.

Suitable aluminum alloys for the conductor include Al alloys of types 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of said alloys is preferably above 99.5%.

Preferably, the electrical conductor is connected to the first contacting portion of the negative terminal pole.

### Method

A method of manufacturing is used to produce the assembly and is characterized by the following steps:
a. At least two energy storage elements according to any one of claims 1 to 7 and the electrical conductor made of aluminum or the aluminum alloy are provided; and
b. the electrical conductor made of aluminum or aluminum alloy is connected to the negative terminal pole of one of the energy storage elements and to a pole of another of the energy storage elements by welding.

Preferably, the welding is effected by means of a laser.

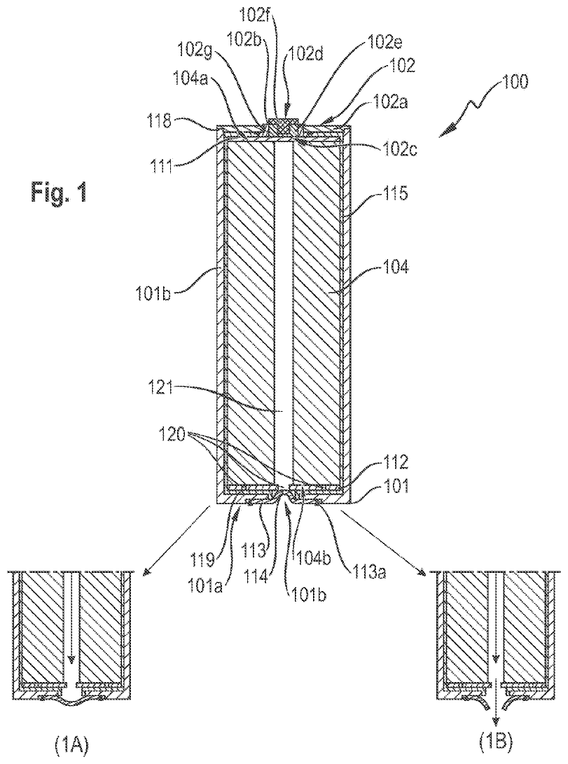

The energy storage element shown in FIG. 1, designed as a cylindrical round cell with a diameter of 26 mm and a height of 105 mm, comprises a housing sealed in an air- and liquid-tight manner and consisting of a metallic housing part 101 of cup-shaped design, which comprises a housing bottom 101a, a cylindrical housing shell 101b and a terminal opening of circular design, and a lid component 102 with a circular circumference. The lid component 102 is disposed in the circular opening of the cup-shaped housing part 101 such that its edge abuts the inside of the cup-shaped housing part 101 along a circumferential contact zone, wherein the edge of the lid component 102 is connected to the cup-shaped housing part 101 via a circumferential weld seam 118. As a result, the lid component 102 is welded into and closes the terminal opening of the cup-shaped housing part 101. The lid component 102 comprises a metallic lid plate 102a and a negative terminal 102b, which is passed through an aperture in the lid plate 102a and is electrically insulated from the lid plate 102. For this purpose, the lid component 102 comprises the annular insulating element 102g.

An electrode-separator assembly 104 is connected in the housing. This is in the form of a cylindrical winding which, in addition to a first flat terminal end face 104a and a second flat terminal end face 104b, has a winding shell 104c located between the end faces. Within the housing, the electrode-separator assembly 104 is axially aligned such that the winding shell 104c abuts the inner surface of the cylindrical housing shell 101b. Only one electrically insulating layer 115, for example made of one or more plastic films, is further disposed between the winding shell 104c and the inner surface. The electrically insulating layer 115 extends over almost the entire inner surface of the housing. Both the side wall of the housing part 101 and large regions of its bottom 101a and the inside of the lid plate 102a are shielded from direct and thus also electrical contact with a component of the electrode-separator assembly 104.

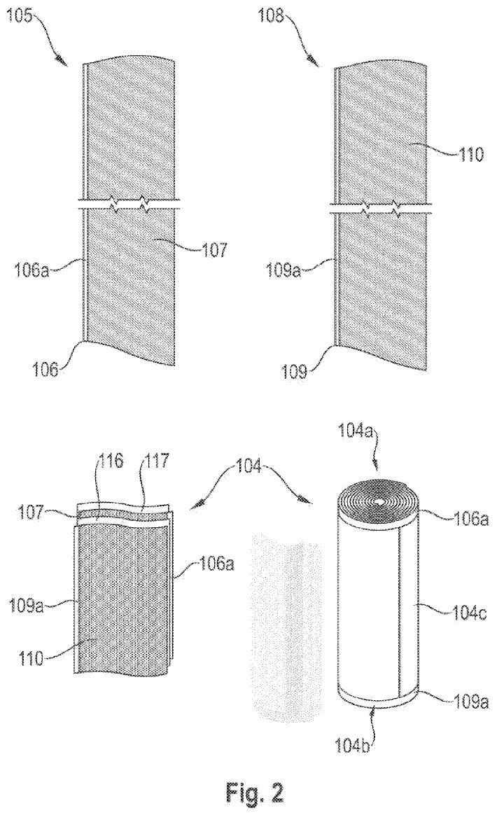

The structure of the electrode-separator assembly 104 is illustrated with reference to FIG. 2. The assembly 104 comprises the ribbon-shaped anode 105 (FIG. 2A) with the ribbon-shaped anode current collector 106 having a first longitudinal edge 106a and a second longitudinal edge parallel thereto. The anode current collector 106 is a foil of copper or nickel. This comprises a strip-shaped main region loaded with a layer of negative electrode material 107, and a free edge strip 106b extending along its first longitudinal edge 106a that is not loaded with the electrode material 107. Further, the assembly 104 comprises the ribbon-shaped cathode 108 (FIG. 2B) with the ribbon-shaped cathode current collector 109 having a first longitudinal edge 109a and a second longitudinal edge parallel thereto. The cathode current collector 109 is an aluminum foil. It comprises a strip-shaped main region loaded with a layer of positive electrode material 110 and a free edge strip 109b extending along its first longitudinal edge 109a, which is not loaded with the electrode material 110. Both electrodes are shown individually in an unwound state.

The anode 105 and cathode 108 are offset from each other within the electrode-separator assembly 104 such that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The staggered arrangement can be seen in FIG. 2C. Also shown there are the two ribbon-shaped separators 116 and 117 that separate electrodes 105 and 108 in the winding.

In FIG. 2 D, the electrode-separator assembly 104 is shown in wound form as it may be used in an energy storage element according to FIG. 1. The electrode edges (106a, 109a) protruding from the end faces (104a, 104b) are clearly visible. The winding shell 104c is formed by a plastic film.

But returning to FIG. 1, the energy storage element 100 further comprises the contact sheet metal member 111, which is seated on the first longitudinal edge 106a of the anode current collector 106 and is connected thereto by welding. Furthermore, the contact sheet metal member 111 is directly connected to the negative terminal 102b which is passed through the aperture in the lid plate 102a. Namely, the latter is welded to the contact sheet metal member 111. The insulating layer 115 prevents contact of the edges of the contact sheet metal member 111 with the housing part 101 and contact of the contact sheet metal member 111 with the lid plate 102a. A second contact sheet metal member 112 is seated on the protruding first edge 109a of the cathode current collector 109 and is connected thereto by welding.

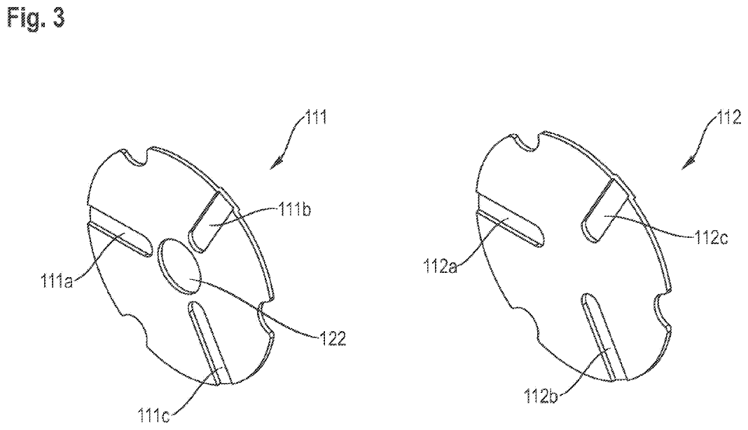

The two contact sheet metal members 111 and 112 are shown in FIG. 3. Both are flat metal discs with a thickness in the range from 150 μm to 350 μm. The metal disc 112 consists of aluminum, while the disc 111 consists of copper or nickel. The contact sheet metal members 111 and 112 have a diameter which corresponds essentially to the diameter of the winding shaped electrode-separator assembly. They thus cover the end faces 104a and 104b almost completely. The contact sheet metal member 112 has a central hole 122 which can be useful, among other things, for impregnating the electrode-separator assembly with an electrolyte. Both contact sheet metal members 111 and 112 each have three beads (111a, 111b, 111c; 112a, 112b, 112c). In the region from these beads, the contact sheet metal members 111 and 112 are welded to the edges 106a and 109a.

The negative terminal 102b shown in FIG. 1 comprises a cup-shaped first part 102e, which comprises a first contacting portion 102c at its bottom. This contacting portion sits directly on the contact sheet metal member 111 and is connected thereto by welding. The welding may be performed, for example, by means of a laser. The cup-shaped part 102e consists of nickel or copper. To facilitate welding, it preferably consists of the same material as the contact sheet metal member 111. Furthermore, the negative terminal 102b comprises a second part 102f made of aluminum or an aluminum alloy. This comprises a second contacting portion 102d. The second part 102f comprises a pin-shaped portion 102g mechanically fixed in the cup-shaped part 102e. Preferably, the second part 102f is press-fitted into the cup-shaped part 102e or fixed in the cup-shaped part 102e by means of a screw connection. Additional fixation by means of welding is possible.

The second contacting portion 102d can be contacted mechanically from outside the housing. Due to its material nature, it can be easily welded to an aluminum current conductor by means of a laser.

The second contact sheet metal member 112 is electrically connected to the cup-shaped housing part 101, exclusively via the metallic membrane 113. Otherwise, the second contact sheet metal member 112 is electrically insulated from the bottom 101a by means of the insulation 119, which may be in the form of a disk, and may optionally also be part of the insulating layer 115.

The membrane 113 closes an aperture 101b in the bottom 101a of the housing part 101. To save space, the bottom 101a has an annular, flat recess on its outer side around the aperture 101b, in which the membrane 113 is fixed to the cup-shaped housing part 101 by welding. Subsequently, the membrane 113 has the annular weld seam 113a. In its center, the metallic membrane 113 has an indentation 114 in the region from which the membrane 113 extends into the housing interior through the aperture 101b. The second contact sheet metal member 112 is connected by welding to the part of the metallic membrane 113 extending into the interior of the housing.

Advantageously, the contact sheet metal member 112 has a plurality of holes 120. Via one of the holes, the aperture 101b is connected to an axial cavity 121 within the electrode-separator assembly 104. If excess pressure occurs within the housing, the pressure can act on the membrane 113 via one or more of the holes. If the pressure is sufficiently high, the indentation 114 is forced outward, wherein the membrane 113 breaks away from the contact plate 112, as shown in FIG. 1A. This breaks electrical contact with the cathode 108 and stops any current flow. If the pressure nevertheless continues to rise, the membrane may burst, see FIG. 1B.

The solution shown is advantageous in that the fuse function is integrated into the housing bottom 101a and thus does not take up any space within the housing. Nevertheless, it is extremely reliable.

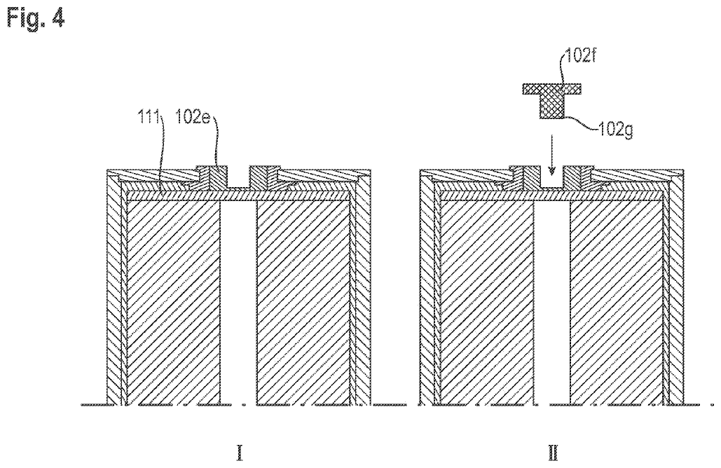

FIG. 4 illustrates the assembly of the negative terminal 102b shown in FIG. 1. For this purpose, the bottom of the cup-shaped first part 102e is first connected to the contact sheet metal member 111 by welding. In the present case, the welding is performed by means of a laser. Then, the pin-shaped portion 102g of the second part 102f is pressed into the cup-shaped part 102e.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An energy storage element, comprising:
an air- and liquid-tight sealed housing, comprising:
a metallic, cup-shaped housing part with a housing bottom and a terminal opening,
a lid component welded into and closing the terminal opening of the cup-shaped housing part, the lid component comprising a metallic lid plate and a negative terminal passed through an aperture in the lid plate and electrically insulated from the lid plate;
an electrode-separator assembly comprising:
a first flat terminal end face, and
a second flat terminal end face,
an anode with an anode current collector having a first edge and a second edge parallel thereto, the anode current collector comprising a main region loaded with a layer of negative electrode material and a free edge strip, extending along the first edge of the anode current collector, which is not loaded with the electrode material,
a cathode with a cathode current collector having a first edge and a second edge parallel thereto, the cathode current collector comprising a main region loaded with a layer of positive electrode material and a free edge strip, extending along the first edge of the cathode current collector, which is not loaded with the electrode material,
wherein the anode and the cathode are arranged within the electrode-separator assembly such that the first edge of the anode current collector protrudes from the first terminal end face and the first edge of the cathode current collector protrudes from the second terminal end face of the electrode-separator assembly; and
a contact sheet metal member seated on the first edge of the anode current collector and connected thereto by welding, the contact sheet metal member being electrically connected to the negative terminal passing through the aperture in the lid plate,
wherein the negative terminal comprises a first contacting portion made of nickel or copper or titanium or a nickel alloy or a copper alloy or a titanium alloy or stainless steel, and a second contacting portion made of aluminum or an aluminum alloy; and
wherein the second contacting portion can be contacted mechanically from outside the housing.

2: The energy storage element of claim 1, comprising at least one of the following additional features:
the cup-shaped housing part comprises aluminum or an aluminum alloy;
the lid plate comprises aluminum or an aluminum alloy.
the lid component comprises a separate positive terminal pole fixed to the lid plat that comprises aluminum or an aluminum alloy; and/or
the cup-shaped housing part and the lid plate and the separate positive terminal pole comprise aluminum or an aluminum alloy.

3: The energy storage element according to claim 1, comprising at least one of the following additional features:
the contact sheet metal member comprises nickel or copper or titanium or a nickel alloy or a copper alloy or a titanium alloy or stainless steel;
the contact sheet metal member comprises the same material as the first contacting portion; and/or
the contact sheet metal member comprises the same material as the anode current collector.

4: The energy storage element according to claim 1, comprising at least one of the following additional features:
the contact sheet metal member has a uniform thickness in a range from 50 μm to 600 μm;
the contact sheet metal member has two opposing flat sides and extends substantially in only one dimension;
the contact sheet metal member is a disc or a rectangular plate;
the contact sheet metal member is dimensioned such that it covers at least 60% of the first terminal end face;
the contact sheet metal member has at least one aperture;
the contact sheet metal member has at least one bead that appears as an elongated depression on one flat side of the contact sheet metal member and as an elongated elevation on the opposite flat side, wherein the contact sheet metal member rests with the flat side carrying the elongated elevation on the first edge of the anode current collector; and/or
the contact sheet metal member is welded to the first edge of the anode current collector in the region from the bead.

5: The energy storage element according to claim 1, comprising at least one of the following additional features:
the energy storage element comprises a second contact sheet metal member which is seated on the first edge of the cathode current collector and is connected thereto by welding;
the second contact sheet metal member is electrically connected to the cup-shaped housing part; and/or
the second contact sheet metal member consists of aluminum or an aluminum alloy.

6: The energy storage element according to claim 1, comprising at least one of the following additional features:
the negative terminal comprises a tubular or cup-shaped first member that comprises the first contacting portion;
the tubular or cup-shaped part consists of nickel or copper or titanium or a nickel alloy or a copper alloy or a titanium alloy or stainless steel;
the negative terminal comprises a terminal tubular or cup-shaped first part having a sheath of nickel or copper or nickel or copper alloy, in particular coated with the nickel alloy or the copper alloy or the nickel alloy or the copper alloy;
the negative terminal comprises a second aluminum or aluminum alloy member that comprises the second contacting portion;
the second part is fixed to the first part mechanically and/or by welding; and/or
the second part comprises a pin-shaped portion that is mechanically fixed in the tubular or cup-shaped part, pressed into the tubular or cup-shaped part or fixed in the tubular or cup-shaped part by a screw connection.

7: The energy storage element according to claim 5, further comprising:
wherein the bottom of the cup-shaped housing part comprises an aperture closed by a metallic membrane,
the metallic membrane is fixed to the cup-shaped housing part by welding,
the metallic membrane comprises an indentation in the region from which the membrane extends through the aperture into the interior of the housing,
the second contact sheet metal member is electrically insulated from the bottom of the housing, and
the second contact sheet metal member is connected by welding to the part of the metal membrane extending into the housing interior.

8: An assembly of energy storage elements, comprising:
at least two energy storage elements according to claim 1; and
an electrical conductor of aluminum or aluminum alloy connected to the negative terminal of a first of the at least two energy storage elements and to a terminal of a second of the at least two energy storage elements by welding.

9: A method of manufacturing an assembly of energy storage elements, the method comprising:
providing at least two energy storage elements according to claim 1 and an electrical conductor made of aluminum or of an aluminum alloy; and
welding the electrical conductor made of aluminum or the aluminum alloy to the negative terminal pole of a first of the at least two energy storage elements and to a pole of a second of the at least two energy storage elements.
